(19) United States
(12) Patent Application Publication
(10) Pub. No.: US 2005/0015201 A1
(43) Pub. Date: Jan. 20, 2005

(54) Method and apparatus for detecting obstacles

(75) Inventors: John Richard Fields, Princeton Jct., NJ (US); John Benjamin Southall, Philadelphia, PA (US)

Correspondence Address: MOSER, PATTERSON & SHERIDAN, LLP;/SARNOFF CORPORATION, 595 SHREWSBURY AVENUE, SUITE 100, SHREWSBURY, NJ, 07702, US

(73) Assignee: Sarnoff Corporation

(21) Appl. No.: 10/621,239

(22) Filed: Jul. 16, 2003

(51) Int. Cl. G08G 1/16

(52) U.S. Cl. 701/301; 340/903; 340/436

(57) ABSTRACT

A method and apparatus for detecting obstacles in off-road applications. A stereo camera and specific image-processing techniques enable a vehicle's vision system to identify drivable terrain in front of the vehicle. The method uses non-drivable residuals (NDR), where the NDR is zero for all terrain that can be easily traversed by the vehicle and greater than zero for terrain that may not be traversable by the vehicle. The method utilizes a depth map having a point cloud that represents the depth to objects within the field of view of the stereo cameras. The depth map is tiled such that the point cloud data is represented by an average (smoothed) value. The method scans pixels in the smoothed depth map to find sequences of “good” points that are connected by line segments having an acceptable slope. Points that lie outside of the acceptable slope range will have an NDR that is greater than zero. The vehicle control system can use the NDRs to accurately make decisions as to the trajectory of the vehicle.

### GOVERNMENT RIGHTS IN THIS INVENTION

This invention was made with U.S. government support under contract number MDA972-01-9-0016. The U.S. government has certain rights in this invention.

### BACKGROUND OF THE INVENTION

1. Field of the Invention

The invention relates to vision systems and, more particularly, the present invention relates to a method and apparatus for detecting obstacles using a vehicular-based vision system.

2. Description of the Background Art

Vehicular vision systems generally comprise a camera (or other sensor) mounted to a vehicle. An image processor processes the imagery from the camera to identify obstacles that may impede the movement of the vehicle. To identify obstacles, a plane is used to model the roadway in front of the vehicle and the image processor renders obstacles as point clouds that extend out of the plane of the roadway. By using such a planar model, the processing of imagery from “on-road” applications of vehicular vision systems is rather simple. The image-processing system must recognize when the point cloud is extending from the roadway plane and deem the point cloud simply to be an obstacle to be avoided.

In “off-road” applications, where the ground upon which the vehicle is to traverse is non-planar, the terrain cannot be modeled as a simple plane. Some applications have attempted to model the off-road terrain as a plurality of interconnecting planes. However, such models are generally inaccurate and cause the vehicle to identify obstacles that could, in reality, be traversed by the vehicle. As such, unnecessary evasive action is taken by the vehicle.

Therefore, there is a need for a method and apparatus of performing improved obstacle detection that is especially useful in “off-road” applications.

### SUMMARY OF THE INVENTION

The invention provides a method and apparatus for detecting obstacles in non-uniform environments, e.g., an off-road terrain application. The apparatus uses a stereo camera and specific image-processing techniques to enable the vehicle's vision system to identify drivable terrain in front of the vehicle. The method uses the concept of a non-drivable residual (NDR), where the NDR is zero for all terrain that can be easily traversed by the vehicle and is greater than zero for terrain that may not be traversable by the vehicle. The method utilizes a depth map having a point cloud that represents the depth to objects within the field of view of the stereo cameras. The depth map is organized into small tiles; each tile is represented by the average of the point cloud data contained within. The method scans columns of pixels in the image to find sequences of “good” points that are connected by line segments having an acceptable slope. Points that lie outside of the acceptable slope range will have an NDR that is greater than zero. From this information regarding obstacles and the terrain before the vehicle, the vehicle control system can accurately make decisions as to the trajectory of the vehicle.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIGS. 1A and 1B depict a vehicle on off-road terrain;

FIG. 2 depicts a block diagram of a vision system in accordance with the present invention;

FIG. 3 depicts a functional block diagram of various components of the vision system in accordance with the present invention;

FIG. 4 depicts a flow diagram of a process of operation of the present invention;

FIG. 5 depicts a terrain model with decision points suggested by the present invention; and

FIG. 6 depicts one column of depth map data as processed by the present invention.

### DETAILED DESCRIPTION

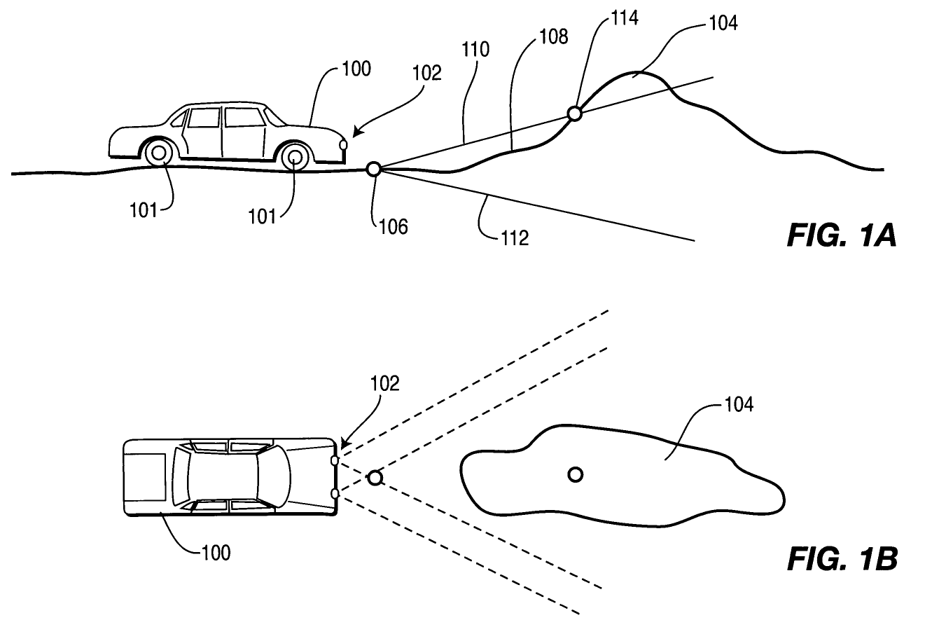

FIG. 1A depicts a side view of a vehicle 100 having a movement system 101 traversing off-road terrain and FIG. 1B depicts a top view of the terrain in FIG. 1A. The vehicle 100 contains a stereo imaging system 102 having at least a pair of sensors or cameras mounted to the front of the vehicle. In one illustrative embodiment, the vision system 102 is capable of processing video at a rate of ten frames per second or faster in real time and produces an obstacle map that has a resolution that is fine enough to identify a pathway that is a little wider than the vehicle itself. The vehicle may be an unmanned ground vehicle (UGV) that uses the obstacle detection method of the present invention to enable the vehicle's control system to direct the vehicle around detected obstacles. Alternatively, the invention could also be used as an obstacle avoidance warning system for a manned vehicle or for a system that detects the slope of terrain to enable a driver to understand whether the slope is traversable by the vehicle without causing damage to the vehicle.

The method does not recognize specific objects but labels areas that are difficult or impossible to traverse. Also, the method does not determine if an area on the other side of an obstacle can be reached, that process is left to the route planner that is responsible for that task.

An advantage of the non-drivable residual (NDR) method of the present invention is that it enables the evaluation of the change in vertical height from one place to another relative to the range of heights that would occur for drivable slopes. As such, the method uses mobility constraints for a particular vehicle and compares the constraints to the slope of the terrain proximate the vehicle. As illustrated in FIG. 1A, the process starts from a “good” point 106 that lies on the surface of the terrain in front of the vehicle. A “good” point is a surface point on terrain that can be traversed by the vehicle, e.g., fulfills a mobility constraint. The stereo images captured by the system 102 are converted into a depth map that shows the depth of points within the field of view of the vehicle's cameras. By processing the images, a depth map can be used to identify the terrain profile 108. Each point in the profile 108 is compared to the good point 106 and the non-drivable residual indicates a departure between the height of the next point along the profile and the interval of heights that could be reached if the same distance were traversed on a drivable slope. As long as the height of the next point lies within the drivable range as indicated by the boundaries 110 and 112, the residual is zero, and the “good” point is updated accordingly. The residual becomes non-zero when the height exceeds the drivable range outside of the boundaries 110 and 112, i.e., above the point 114 on the terrain profile 108. The “good” point becomes fixed, and subsequent points are evaluated relative to this reference. The residual itself is measured from the appropriate limiting slope line 110. If the non-drivable residual exceeds a threshold, then an impassible obstacle has been detected, e.g., the mobility constraint is exceeded for the particular vehicle. In the example shown in FIGS. 1A and 1B, the vision system will deem the obstacle 104 non-traversable by the vehicle. Further examples will be discussed below as the hardware and software of the present invention are described.

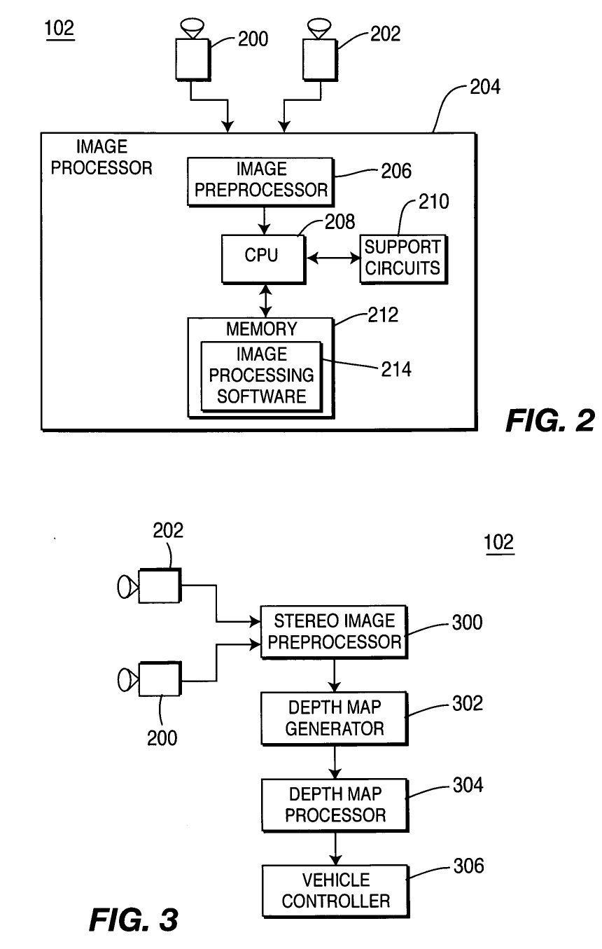

FIG. 2 depicts a block diagram of one embodiment of the hardware that can be used to form the vision system 102. The vision system 102 comprises a pair of charge coupled device (CCD) cameras 200 and 202 that form a stereo imaging system. The vision system 102 further comprises an image processor 204 that is coupled to the cameras 200 and 202. The image processor 204 comprises an image preprocessor 206, a central processing unit (CPU) 208, and support circuits 210 and memory 212. The image preprocessor 206 comprises circuitry that is capable of calibrating, capturing and digitizing the stereo images from the cameras 200 and 202. Such an image preprocessor is the Acadia integrated circuit available from Pyramid Vision Technologies of Princeton, N.J. The central processing unit 208 is a general-purpose computer or microprocessor. Support circuits 210 are well known and are used to support the operation of the CPU 208. These circuits include such well-known circuitry as cache, power supplies, clock circuits, input/output circuitry and the like. Memory 212 is coupled to the CPU 208 for storing a database, an operating system and image processing software 214. The image processing software 214, when executed by the CPU 208, forms part of the present invention.

FIG. 3 depicts a functional block diagram of the various modules that make up the vision system 102. The cameras 200 and 202 are coupled to the stereo image preprocessor 300 that produces stereo imagery. The stereo imagery is processed by the depth map generator 302 to produce a depth map of the scene in front of the vehicle. The depth map comprises a two-dimensional array of pixels, where a value of a pixel represents the depth to a point in the scene. The depth map is processed by the depth map processor 304 to perform piecewise smoothing of the depth map and identify obstacles within the path of the vehicle. The obstacle's detection information is coupled to the vehicle controller 306 such that the vehicle controller can take action to avoid the obstacle, warn a driver, plan and execute an optimal route, and the like.

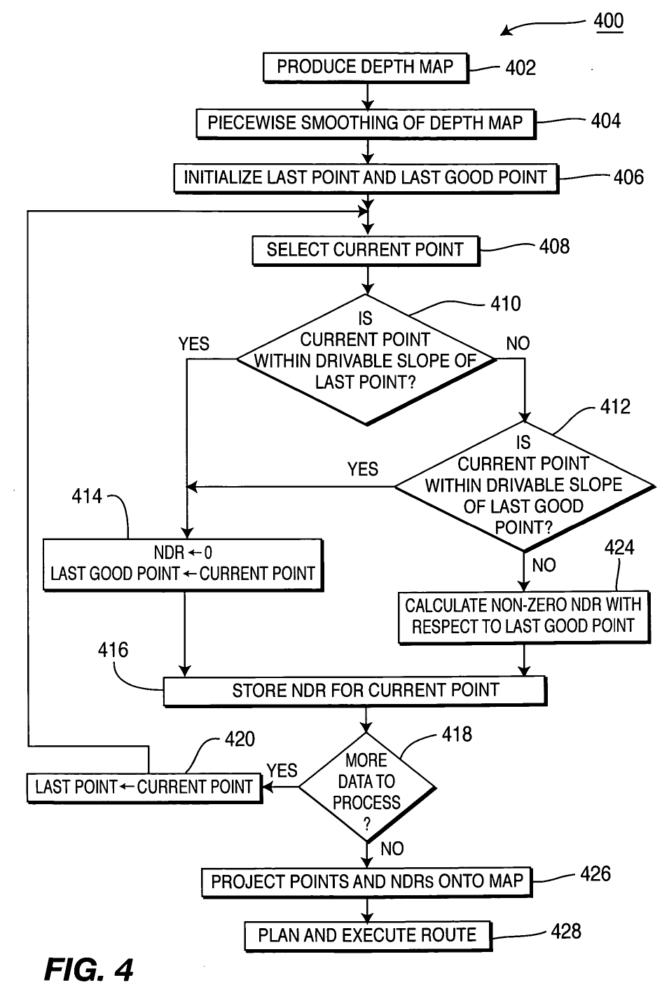

FIG. 4 depicts a method 400 of operation of the vision system illustrated in FIGS. 1-3. The method 400 begins, at step 402, by producing a depth map of the scene in front of the vehicle. Generally, this is accomplished by the Acadia circuitry. At step 404, the depth map is then piecewise smoothed. The smoothing is performed by dividing the depth map into small portions, e.g., 5 pixel by 5 pixel blocks. The planar tile is fit to the pixels in each of the blocks. The center of each tile is used as a “point” in processing the depth map. Then, at step 406, an initial last point and an initial last good point are established. These initial values can be default values or values determined by the particular scene. At step 408, a current point is selected within the smoothed depth map. The method 400 generally processes the smoothed depth map by selecting a point within a selected column of points, processing all the points in a column and then processing the next adjacent column of points and so on. Alternatively, a row of points across all columns can be processed simultaneously, and then each higher row of points is processed until all the points in the smoothed depth map are processed. To ensure accuracy, the points identified as good can be compared in rows of points to ensure consistency or to compensate for data drop-outs.

At step 410, the method 400 determines whether the current point is within the drivable slope of the last point. If the answer is negative, the method 400 proceeds to step 412 and determines if the current point is within the drivable slope of the last good point. If the current point is within the drivable slope, or if the current point was determined in step 410 to be within the drivable slope of the last point, at step 414, the NDR for the current point is set to 0, and the last good point is updated to the current point. Then, at step 416, the zero NDR for the current point is stored. At step 418, the method 400 determines whether there is more,data to be processed. If there is more data, the last point is updated to the current point at step 420 and a loop is made back to step 408 for the selection of a new, current point.

However, if during step 412 a determination is made that the current point is not within the drivable slope of the last good point, a non-zero NDR with respect to the last good point is calculated for the current point at step 424. At step 416, the non-zero NDR is then stored for the current point. At step 418, the method queries whether more data is to be processed. If the query is affirmatively answered, the method 400 proceeds to step 420 and sets the current point to the last point and proceeds to step 408 to process the next point

When a determination is made in step 418 that there is no more data to be processed, the method 400 proceeds to step 426 wherein the points and NDRs are projected onto a map. At step 428, the map is used to plan a route that will avoid any detected obstacle. The plan may then be executed. For example, the map contains a two-dimensional matrix of values where zero value and low values represent passable terrain (i.e., terrain that does not exceed the mobility constraint of the vehicle) and high values represent impassable terrain (i.e., terrain that exceeds the mobility constraint of the vehicle). The specific thresholds assigned to produce “low” and “high” indications are defined by the particular vehicle that is traversing the terrain. Consequently, the map identifies regions in which the mobility constraints of the particular vehicle are exceeded and not exceeded.

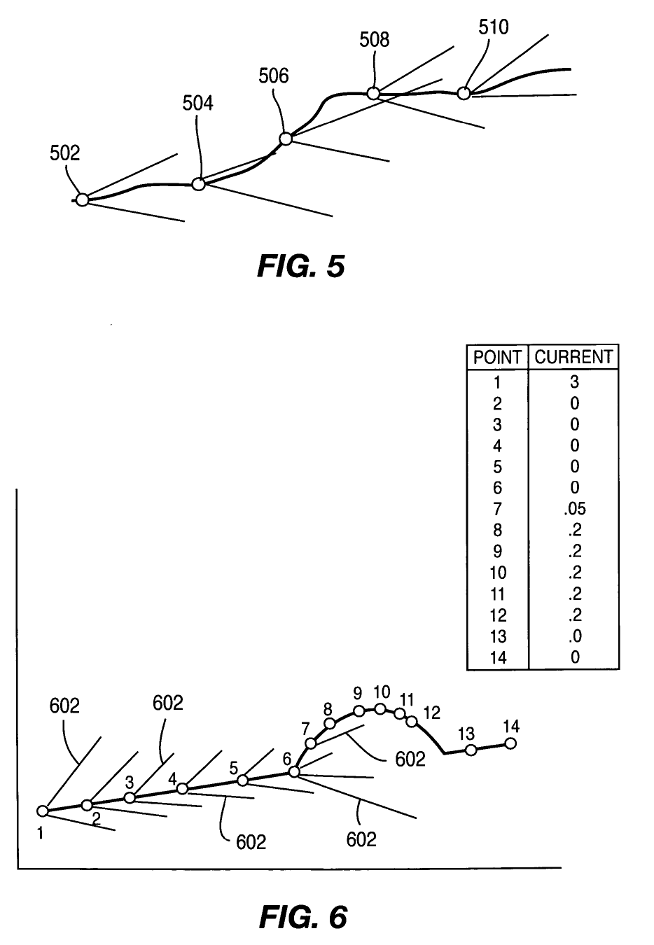

FIG. 5 depicts a schematic view of various points along a slope as processed by the method of FIG. 4. The first point 502 is assumed to be “good”. The second point 504 is within the drivable interval of the boundaries extending from the first point, as such, point 504 is deemed good. The third point 506 is outside the drivable interval of the second point, and its residual is calculated as discussed below. The fourth point 508 is also outside the drivable interval of the third point 506, and its residual is computed with respect to the drivable interval of the second point 504. This “frozen” last good point 504 becomes a fixed local reference for evaluating the severity of a potential obstacle. The obstacle ends with point.510 since the elevation is within the drivable range of the previous point 508. In this example the vehicle would easily traverse the terrain through points 502 and 504; however, the NDR of point 506 would be evaluated to see if it is above the threshold for the vehicle to traverse the terrain at that angle. The same is true for the terrain at point 508. If the NDR is severe enough, than the method 400 will deem the terrain at points 506 and 508 to be non-drivable. However, if the NDR is not substantial, then the terrain feature (such as a small rock) is considered to be passable, even though the slope is outside of the boundaries extrapolated from point 504.

FIG. 6 illustrates how the method of the present invention operates on data representing a large rock on a small incline. The camera viewing the scene is located to the left of the figure. The lines 602 indicate drivable slopes. The diamonds are points that are mapped into pixels in one column of the smoothed depth map. The first 6 points are “good” points. The next point is outside of the limits of the boundaries but is not far enough from the drivable slope to be classified as an obstacle. Points 8 through 11 exceed a threshold and are classified as obstacles. The first point visible above the rock is again a good point as are points 13 and 14. The table to the right of the figure lists the non-drivable residual for each point. The threshold in this case is set at 0.1.

The following calculation is applied to pixels (points) in one column of the image at a time. If there is a stereo dropout (unavailable data), the computation, continues with the next available pixel. The only state variables are the last point and the last good point. As mentioned above, the points may be processed simultaneously in rows and further comparitive processing can be performed to ensure accuracy of the computations.

Let (X,Y,Z) be the world coordinates of the point imaged at pixel (x,y) in the image. Assume that the world coordinates have been suitably transformed so that the Y axis is vertical. In practice, this transformation is achieved with input from an inertial navigation system (INS) which relates the camera pose to the world system. (In the usual system, X points right, Y points down, and Z points forward.) Let (X,Y,Z)_{L} be the coordinates of the last point, and (X,Y,Z)_{G} be the coordinates of the last “good” point. The initial values of these points are:
(X,Y,Z)_{L}=(X,Y,Z)_{G}=(0,−h,0)
where h is the camera height.

To compute the non-drivable residual (NDR or R_{nd}) for point (X,Y,Z), first compute the displacement from the last point:
(ΔX,ΔY,ΔZ)_{L}=(X,Y,Z)−(X,Y,Z)_{L}
The distance traveled (projected onto the XZ plane) is
d_{L}=\sqrt{ΔX_{L}²+ΔZ_{L}²}
Let s_{di} be the maximum slope of a drivable incline (uphill or downhill). The limiting values for a drivable ΔY are:
ΔYᵤₚₕᵢₗₗ=−s_{di}d_{L} and ΔY_{downhill}=s_{di}d_{L}
If ΔYᵤₚₕᵢₗₗ≦ΔY≦ΔY_{downhill}, then the method has found a nominally flat, level place. Set R_{nd}=0 and update the last point and the last good points:
(X,Y,Z)_{L}←(X,Y,Z) and (X,Y,Z)_{G}←(X,Y,Z).
Otherwise, the change in elevation indicates a possible obstacle. To measure the severity of the height change, first the method computes the distance from the last good point:
d_{G}=\sqrt{ΔX_{G}²+ΔZ_{G}²} where (ΔX,ΔY,ΔZ)_{G}=(X,Y,Z)−(X,Y,Z)_{G}
The ΔY limits for computing the residual are:
ΔYᵤₚₕᵢₗₗ=−s_{di}d_{G} and ΔY_{downhill}=s_{di}d_{G}
The residual is given by:

$${R}_{nd} = \{ \begin{matrix}Δ {Y}_{G} - Δ {Y}_{downhill} , & Δ {Y}_{downhill} < Δ {Y}_{G} \\ 0 & Δ {Y}_{uphill} \leq Δ {Y}_{G} \leq Δ {Y}_{downhill} \\ Δ {Y}_{G} - Δ {Y}_{uphill} & Δ {Y}_{G} < Δ {Y}_{uphill}\end{matrix}$$

The residual is compared to a pre-defined threshold. If the residual is greater than the threshold, then the potential obstacle is deemed an actual obstacle to be avoided, i.e., the terrain is not traversable. Lastly, the method always updates the last point: (X,Y,Z)_{L}←(X,Y,Z) and, if R_{nd}=0, then the method also updates the last good point: (X,Y,Z)_{G}←(X,Y,Z).

Spurious values in the obstacle map can be suppressed by applying the method to average values of (X,Y,Z). Most of the experiments and tests have been done with averages computed for non-overlapping blocks of 5×5 pixels. Good results have also been obtained for overlapping, variable, sized patches ranging from 40 pixels square in the foreground to a minimum of 8 pixels square at row 68 out of 320. The main issue with the larger, overlapping averages is the increase in computation time. To obtain average values of (X,Y,Z), the quantity (1/Z) is approximated by a linear function of the pixel coordinates (x, y) in the patch. The value of (1/Z) obtained from the fit is used to compute Z at the center of the patch. X and Y are then computed from Z, the pixel coordinates, and the camera center and focal length.

The average is computed in camera coordinates, and then transformed to world coordinates. The transformation matrix includes the camera-to-vehicle rotation obtained from camera calibration, and the vehicle-to-world transformation obtained from the vehicle pose sensors.

While foregoing is directed to various embodiments of the present invention, other and further embodiments of the invention may be devised without departing from the basic scope thereof, and the scope thereof is determined by the claims that follow.

1. A method of detecting obstacles comprising:
producing a depth map of a scene containing terrain; and
processing the depth map to identify regions that do not exceed a mobility constraint for a vehicle, and regions that do exceed the mobility constraint of the vehicle.

2. The method of claim 1 wherein the processing step includes processing data in the depth map to determine a height change of the terrain over a distance represented by pixels in the depth map.

3. The method of claim 1 wherein the processing step further comprises:
computing an amount by which the mobility constraint is exceeded in a region.

4. The method of claim 3 wherein step of computing the amount by which the mobility constraint is exceeded further comprises computing a non-drivable residual.

5. The method of claim 4 wherein the non-drivable residual represents positive or negative elevations beyond limits computed from slope constraints.

6. The method of claim 1 wherein the depth map is a smoothed depth map.

7. The method of claim 6 further comprising:
dividing the depth map into blocks of pixels;
fitting a plane to each of the blocks of pixels; and
identifying a point in the center of each plane as points that form the smoothed depth map.

8. The method of claim 6 further comprising:
identifying a current point (X,Y,Z) representing a current location within the depth map;
subtracting a last point (X,Y,Z)_{L}, which represents a last location within the depth map, from the current point to derive a displacement (ΔX, ΔY, ΔZ);
computing a distance traveled (d_{L}) between the last point and the current point;
providing a maximum slope (s_{di}) for a drivable incline;
determining uphill and downhill limiting values (ΔYᵤₚₕᵢₗₗ=−s_{di}d_{L} and ΔY_{downhill}=s_{di}d_{L}) for a drivable vertical displacement ΔY by multiplying the maximum slope by the distance traveled;
if the vertical displacement ΔY is less than the limiting values, the terrain within the distance traveled is determined to be drivable;
if the vertical displacement ΔY is greater than the limiting values, the terrain within the distance traveled Is determined to contain a potential obstacle; and
if a potential obstacle is detected, computing a non-drivable residual to determine whether the potential obstacle is an obstacle.

9. The method of claim 4 wherein the step of computing the non-drivable residual comprises:
identifying a prior location in the depth map that does not contain an obstacle as a last good point (X,Y,Z)_{G};
computing a second distance traveled (d_{G}) from the last good point to the current point (X,Y,Z);
computing a residual limiting value (ΔYᵤₚₕᵢₗₗ=−s_{di}d_{G} and ΔY_{downhill}=s_{di}d_{G}) for the residual (ΔR_{nd}) by multiplying the maximum slope with the second distance traveled; and
computing the residual as:
$${R}_{nd} = \{ \begin{matrix}Δ {Y}_{G} - Δ {Y}_{downhill} , & Δ {Y}_{downhill} < Δ {Y}_{G} \\ 0 & Δ {Y}_{uphill} \leq Δ {Y}_{G} \leq Δ {Y}_{downhill} \\ Δ {Y}_{G} - Δ {Y}_{uphill} & Δ {Y}_{G} < Δ {Y}_{uphill}\end{matrix}$$
if the residual is greater than a predefined threshold, then the potential obstacle is an obstacle;
updating the last point with the current point; and
if the residual is zero, then updating the last good point with the current point.

10. Apparatus for detecting obstacles comprising:
a stereo image processor for producing stereo imagery of a scene containing terrain;
a depth map generator for processing the stereo imagery and producing a depth map, and
a depth map processor for processing the depth map to identify regions that do not exceed a mobility constraint for a vehicle, and regions that do exceed the mobility constraint of the vehicle.

11. The apparatus of claim 10 wherein the depth map processor further comprises:
means for computing an amount by which the mobility constraint Is exceeded in a region.

12. The apparatus of claim 10 wherein the depth map is a smoothed depth map.

13. The apparatus of claim 12 further comprising:
means for dividing the depth map into blocks of pixels;
means for fitting a plane to each of the blocks of pixels; and
means for Identifying a point in the center of each plane as points that form the smoothed depth map.

14. The apparatus of claim 10 wherein the depth map processor comprises:
means for processing each column of data in the depth map to determine the height change of the terrain over the distance represented by pixels in the depth map.

15. The apparatus of claim 14 wherein the depth map processor comprises means for computing a non-drivable residual.

16. The apparatus of claim 15 wherein the non-drivable residual represents the positive or negative elevations beyond limits computed from slope considerations.

17. The apparatus of claim 10 further comprising:
means for identifying a current point (X,Y,Z) representing a current location within the data;
means for subtracting a last point (X,Y,Z)_{L} representing a last location within the data from the current point to derive a displacement (ΔX, ΔY, ΔZ);
means for computing a distance traveled (d_{L}) between the last point and the current point;
means for providing a maximum slope (s_{di}) for a drivable incline;
means for determining uphill and downhill limiting values (ΔYᵤₚₕᵢₗₗ=−s_{di}d_{L} and ΔY_{downhill}=s_{di}d_{L}) for a drivable vertical displacement ΔY by multiplying the maximum slope by the distance traveled;
if the vertical displacement ΔY is less than the limiting values, the terrain within the distance traveled is determined to be drivable;
if the vertical displacement ΔY is greater than the limiting values, the terrain within the distance traveled is determined to contain a potential obstacle; and
if a potential obstacle is detected, the depth map processor computes a non-drivable residual to determine whether the potential obstacle is an obstacle.

18. The apparatus of claim 15 wherein the depth map processor further comprises:
means for identifying a good point (X,Y,Z)_{G} as a prior location that does not contain an obstacle;
means for computing a second distance traveled (d_{G}) from the last good point to the current point (X,Y,Z);
means for computing a residual limiting value (ΔYᵤₚₕᵢₗₗ=−s_{di}d_{G} and ΔY_{downhill}=s_{di}d_{G}) for the residual (R_{nd}) by multiplying the maximum slope with the second distance traveled; and
means for computing the residual as:
$${R}_{nd} = \{ \begin{matrix}Δ {Y}_{G} - Δ {Y}_{downhill} , & Δ {Y}_{downhill} < Δ {Y}_{G} \\ 0 & Δ {Y}_{uphill} \leq Δ {Y}_{G} \leq Δ {Y}_{downhill} \\ Δ {Y}_{G} - Δ {Y}_{uphill} & Δ {Y}_{G} < Δ {Y}_{uphill}\end{matrix}$$
if the residual is greater than a predefined threshold, then the potential obstacle is an obstacle.

19. An obstacle detecting system comprising:
a vehicle having a movement system for moving the vehicle across a terrain;
a stereo image processor mounted to the vehicle, the stereo image processor for producing stereo imagery of a scene containing the terrain;
a depth map generator for processing the stereo Imagery and producing a depth map; and
a depth map processor for processing the depth map to identify regions that do not exceed a mobility constraint for the vehicle, and regions that do exceed the mobility constraint of the vehicle.

20. The obstacle detecting system of claim 19 further including:
an obstacle detector responsive to the depth map processor, the obstacle detector for identifying an obstacle in the path of the vehicle that exceeds the mobility constraint of the vehicle; and
a control system that controls the movement system so as to move the vehicle around the identified obstacle.

21. The obstacle detecting system of claim 19 further including:
an obstacle detector responsive to the depth map processor, the obstacle detector for identifying an obstacle in the path of the vehicle that exceeds the mobility constraint of the vehicle; and
a warning system that signals when an obstacle in the path of the vehicle is Identified.

22. The obstacle detecting system of claim 19 wherein the depth map processor includes means for computing an amount by which the mobility constraint Is exceeded In a region, and wherein the depth map is a smoothed depth map.

23. The obstacle detecting system of claim 22 further comprising:
means for dividing the depth map into blocks of pixels;
means for fitting a plane to each of the blocks of pixels; and
means for identifying a point In the center of each plane as points that form the smoothed depth map.

24. The obstacle detecting system of claim 19 wherein the depth map processor Includes means for processing each column of data in the depth map to determine the height change of the terrain over the distance represented by pixels in the depth map, and means for computing a non-drivable residual that represents the positive or negative elevations beyond limits computed from slope considerations.

25. The obstacle detecting system of claim 19 further comprising:
means for identifying a current point (X,Y,Z) representing a current location within the data;
means for subtracting a last point (X,Y,Z)_{L} representing a last location within the data from the current point to derive a displacement (ΔX, ΔY, ΔZ);
means for computing a distance traveled (d_{L}) between the last point and the current point;
means for providing a maximum slope (s_{di}) for a drivable incline;
means for determining uphill and downhill limiting values (ΔYᵤₚₕᵢₗₗ=s_{di}d_{L} and ΔY_{downhill}=s_{di}d_{L}) for a drivable vertical displacement ΔY by multiplying the maximum slope by the distance traveled;
if the vertical displacement ΔY is less than the limiting values, the terrain within the distance traveled is determined to be drivable;
if the vertical displacement ΔY is greater than the limiting values, the terrain within the distance traveled is determined to contain a potential obstacle; and
if a potential obstacle is detected, the depth map processor computes a non-drivable residual to determine whether the potential obstacle is an obstacle.

26. The obstacle detecting system of claim 19 wherein the depth map processor further comprises:
means for identifying a good point (X,Y,Z)_{G} as a prior location that does not contain an obstacle;
means for computing a second distance traveled (d_{G}) from the last good point to the current point (X,Y,Z);
means for computing a residual limiting value (ΔYᵤₚₕᵢₗₗ=−s_{di}d_{G} and ΔY_{downhill}=s_{di}d_{G}) for the residual (R_{nd}) by multiplying the maximum slope with the second distance traveled; and
means for computing the residual as:
$${R}_{nd} = \{ \begin{matrix}Δ {Y}_{G} - Δ {Y}_{downhill} , & Δ {Y}_{downhill} < Δ {Y}_{G} \\ 0 & Δ {Y}_{uphill} \leq Δ {Y}_{G} \leq Δ {Y}_{downhill} \\ Δ {Y}_{G} - Δ {Y}_{uphill} & Δ {Y}_{G} < Δ {Y}_{uphill}\end{matrix}$$
if the residual is greater than a predefined threshold, then the potential obstacle is an obstacle.
